(19) United States
(12) Patent Application Publication
(10) Pub. No.: US 2009/0243813 A1
(43) Pub. Date: Oct. 1, 2009

(54) WIRELESS PROGRAMMING OF NON-VOLATILE MEMORY WITH NEAR-FIELD UHF COUPLING

(76) Inventors: Joshua R. Smith, Seattle, WA (US); Daniel Yeager, Kennewick, WA (US); Mostafa N. Abdulla, Rancho Cordova, CA (US); Sean Eilert, Penryn, CA (US)

Correspondence Address: INTEL CORPORATION;c/o CPA Global, P.O. BOX 52050, MINNEAPOLIS, MN, 55402, US

(21) Appl. No.: 12/054,729

(22) Filed: Mar. 25, 2008

(51) Int. Cl. H04B 7/00

(52) U.S. Cl. 340/10.51

(57) ABSTRACT

Near-Field UHF wireless coupling may be used to write data into a non-volatile memory in a device, thus allowing for changes to be made to the device after that product has been manufactured. Energy from the received wireless signal may be used to power sufficient circuitry in the device so that the programming does not require an on-board power source such as a battery. In many cases, the device may be programmed after it has been packaged for shipment/sale, without removing the device from the package. In some embodiments, a multi-segment antenna may be used to program multiple such devices at the same time by the same Near-Field UHF signal.

### BACKGROUND

Many electronic devices use non-volatile memory to hold information such as configuration data, start-up parameters, software, etc., that may need to be changed after the device has been manufactured. Conventional techniques for changing this data include powering up the device and then changing the data through manual keyboard entry, or through one of the device's peripherals, or through one of the device's communications interfaces. This is somewhat cumbersome and time-consuming, especially if the electronic device has already been packaged for shipment or sale.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a receiver and programmable non-volatile (NV) memory, according to an embodiment of the invention.

FIG. 2 shows a flow diagram of a method of wirelessly programming a NV memory using Near-Field UHF signals, according to an embodiment of the invention.

FIG. 3 shows a system for wirelessly programming multiple NV memories at the same time, according to an embodiment of the invention.

FIG. 4 shows completed products being wirelessly programmed, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” indicates that two or more elements are in direct physical or electrical contact with each other. “Coupled” indicates that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions stored in or on a computer-readable medium, which may be read and executed by one or more processors to enable performance of the operations described herein. A computer-readable medium may include any mechanism for storing, transmitting, and/or receiving information in a form readable by a machine (e.g., a computer). For example, a computer-readable medium may include a tangible storage medium, such as but not limited to read only memory (ROM); random access memory (RAM); magnetic disk storage media; optical storage media; flash memory, phase change memory, etc. A computer-readable medium may also include a non-tangible medium carrying a propagated signal which has been modulated to encode the instructions, such as but not limited to electromagnetic, optical, or acoustical carrier wave signals.

The term “wireless” and its derivatives may be used to describe circuits, devices, systems, methods, techniques, communications channels, etc., that communicate data by using modulated electromagnetic radiation through a non-solid medium. The term does not imply that the associated devices do not contain any wires, although in some embodiments they might not.

Various embodiments of the invention pertain to using Near-Field Ultra-High Frequency (Near-Field UHF, where UHF is limited to the 300 megahertz to 3 gigahertz frequency band, corresponding to a wavelength between approximately 39 inches and 3.9 inches) wireless signals to program a non-volatile memory in an in-circuit device, with the RF power received through an antenna on the device being used to provide operating power to the non-volatile memory and to the circuitry associated with its programming. Note: for the purposes of this document, ‘programming’ a memory indicates writing new information into the memory and/or updating old information in that memory. In some embodiments, proper choice of antenna size and shape may limit the received signal primarily to the magnetic portion of the electromagnetic signal, or alternately, primarily to the electric portion of the electromagnetic signal. A segmented antenna on the programming apparatus may also be used to program multiple devices at the same time.

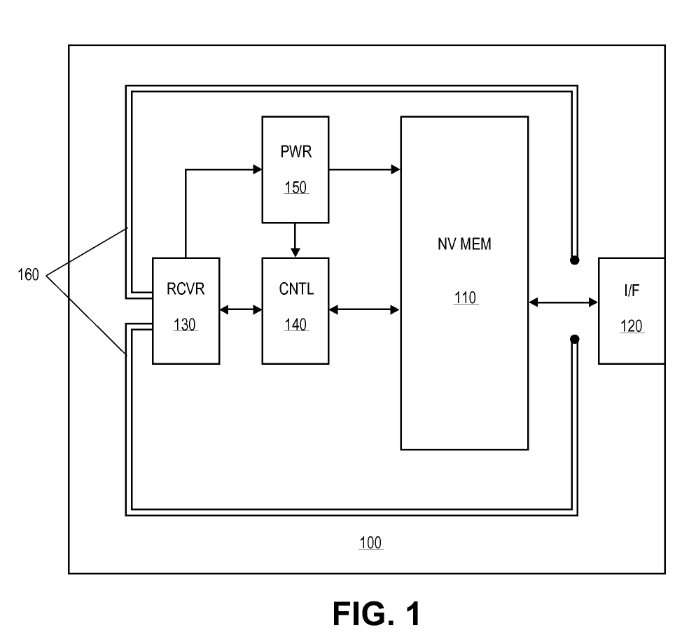

FIG. 1 shows a receiver and programmable non-volatile (NV) memory, according to an embodiment of the invention. In the illustrated embodiment, a single integrated circuit 100 contains the NV memory 110, a wired (i.e., signals are transferred through solid conductors rather than wirelessly) interface 120 so the NV memory can be written to or read by devices external to the NV memory, an antenna 160, a receiver 130 to receive wireless RF signals through the antenna 160, with the signals containing data to program into the NV memory, a controller 140 to control the programming of the NV memory with that data, and a power circuit 150 to accumulate electrical energy received through the antenna 160 and provide that accumulated energy as operational power to the controller 140 and NV memory 110. The receiver 130 and antenna 160 may also work together to transmit information wirelessly by backscattering a modulated version of the received signal. Although all this circuitry is shown in a single integrated circuit 100, in some embodiments parts of it (e.g., the NV memory 110) may be located in one or more separate integrated circuits.

Particularly noteworthy is the fact that the illustrated antenna 160 is contained entirely within the integrated circuit, although in other embodiments the antenna 160 may be placed on the substrate on which the integrated circuit is mounted. In some embodiments, the antenna may be implemented as a trace on the die or substrate, and may take various shapes, such as a coil, or the “C” shape shown in FIG. 1. Regardless of the shape or the method of implementing it, the small electrical size of the antenna (for example, no more than one-half, or one-fourth, or one-tenth of the wavelength) may make it much shorter than an antenna that would normally be used to receive such RF signals. In some embodiments, the radio frequency used is approximately 915 megahertz (MHz), with a corresponding wavelength of approximately 12.9 inches, although other embodiments may use other frequencies/wavelengths. A conventional antenna for use at this wavelength may have an electrical length of at least 12 inches, whereas an antenna located wholly on the integrated circuit may be limited to, for example, less than one inch in electrical length due to the small size of the integrated circuit. This mandates that the received signal be comparatively strong, which may in turn be accomplished by placing the transmitter very close to the receiver. In some embodiments, for example, the coupling distance between the transmitting and receiving antennas may be no more than one wavelength. Even shorter distances, such as no more than one-half wavelength or one-fourth wavelength may be used. In some embodiments, this close spacing between the transmitting and receiving antennas may provide some inductive coupling between the two antennas, similar to the coils of a transformer, so that the received signal is composed primarily of the magnetic portion of the electromagnetic signal. Other embodiments may produce a received signal composed primarily of the electric portion of the electromagnetic signal.

For the purposes of this disclosure, a receive antenna with an electrical length of no more than one half wavelength of the received RF signal, defines Near-Field coupling. This distinguishes it from the more common types of Far-Field propagating signal types of wireless communications, including those that harvest operating power from the received signal.

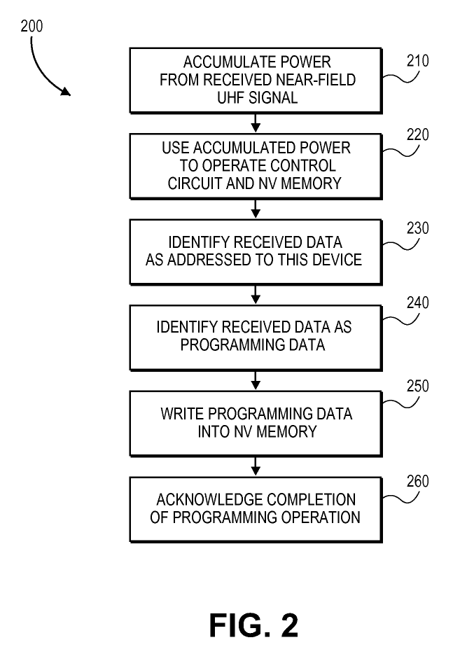

FIG. 2 shows a flow diagram of a method of wirelessly programming an NV memory using Near-Field UHF signals, according to an embodiment of the invention. In flow diagram 200, at 210 a device may receive a wireless Near-Field UHF signal through an antenna and accumulate a portion of the electrical energy received through that signal. Various techniques for receiving and storing such energy are known and are not repeated here. Once sufficient energy has been accumulated in this manner, this accumulated energy may be used at 220 to provide operational power to the NV memory, and to the control circuitry used to program that NV memory.

The received wireless signal will also be modulated to contain data. Since more than one receiver might be located within range of the transmitter, in some embodiments this data may contain a destination address specifying the intended receiver. At 230, the destination address may be identified to determine if this particular sequence is addressed to this device. Such an address might specify only this one device, or in some instances might specify a group of devices sharing a common address. If the destination address is not for this device, then the remaining data may be ignored. In still another embodiment, there may be no destination address. In such an instance, the reprogramming conditions may be controlled so that the programming signal will not be received and used by any device that it is not intended for.

However, if the signal is intended for this device, regardless of how such intent is determined, then the data may be further examined at 240 to determine if it contains programming data. (In some embodiments, the incoming signal may indicate that other, non-programming tasks are to be performed, but only the programming task is identified here in further detail. If no such non-programming tasks are allowed, then operation 240 may be skipped.)

When a suitable portion of the programming data has been received, that portion may be written into the NV memory at 250. In some embodiments, this new data may be considered temporary data until the entire amount of data has been received, verified, and written. Then the temporary data may be designated as the new configuration data, either by changing one or more pointers in the memory, or by copying the temporary data to its permanent location.

Because wireless communications are so susceptible to error, loss of data, or other corruption, the receiving device may acknowledge correct receipt of any data through the aforementioned backscattering. Parity, CRC, low density parity check, Digital Fountain codes, or other data checks may be used to verify the data was received correctly, and in some embodiments data correction techniques may be used to correct the error in this device, thereby avoiding having to retransmit that data. Such techniques are known, and are not repeated here. Regardless of the techniques used, at some point the device may need to acknowledge receipt of the correct data. In some embodiments, this may be done multiple times at various intervals throughout the receiving process, by acknowledging correct receipt of individual segments of the data. In other embodiments, typically involving only a comparatively small amount of new data, only a single acknowledgement at the end may be necessary, as shown at 260. In some embodiments, communication from the device 100 back to the programmer (including acknowledgements) may be made through a technique called backscattering, which involves modulating the impedance of the device's antenna so that a modulated version of the received signal is reflected back to the programmer.

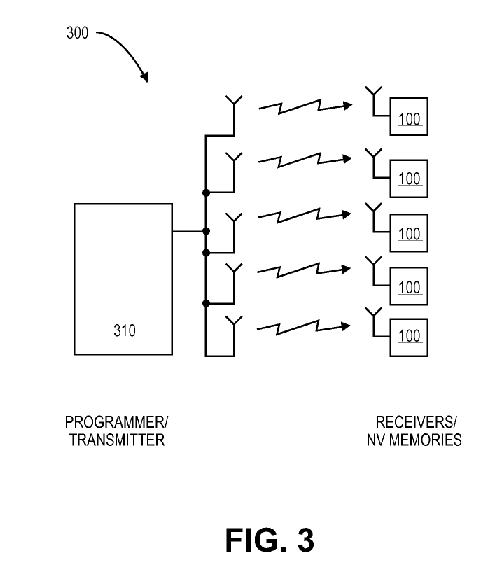

FIG. 3 shows a system for wirelessly programming multiple NV memories at the same time, according to an embodiment of the invention. When multiple devices are to be programmed with the same data, it may be efficient to program more than one of them at a time. In the illustrated embodiment, a programming device 310 may simultaneously transmit the data to multiple devices 100, each of which may go through the process of FIG. 2. A common address for multiple devices could be used in this instance, as previously described. Alternately, a no-address technique may be used, also as previously described. If necessary, programmer 310 may use various techniques to receive and identify acknowledgements from the various devices 100. FIG. 3 shows five devices 100 being programmed by a programmer 310 at the same time, but any feasible number may be programmed at once.

In some embodiments, a single antenna on programmer 310 may be used to communicate with multiple receivers. However, depending on the number of such receivers, and how they are physically placed with respect to the programmer, this may not be practical. To get close enough to each receiver to use Near-Field UHF, the programmer 310 may need to use multiple antennas, or the multi-segment antenna shown, so that each antenna or segment may be close to its intended receiver, and also have the correct electrical length for the frequency being used. These multiple antennas or antenna segments may have any feasible physical shape, such as but not limited to a circular shape. As a practical matter, in some instances shielding may be used to isolate each receiver 100 from the others, to isolate each antenna segment on the programmer from the other segments, and/or to isolate the entire programming system from other wireless systems that may be nearby, including other similar reprogramming systems. In some embodiments, each device being programmed may be located within a certain maximum distance of its associated antenna segment in the programmer, such as but not limited to a maximum of one wavelength, one-half wavelength, or one-fourth wavelength of the wireless signal being used, although other embodiments may not be limited in this manner. In some embodiments, the receive antenna on each device being programmed may have an electrical length of no more than one-half wavelength.

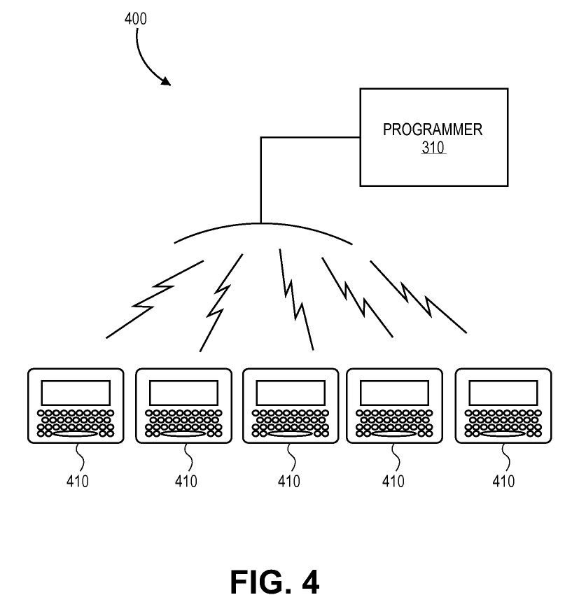

FIG. 4 shows completed products being wirelessly programmed, according to an embodiment of the invention. In system 400, a programmer 310 may be used to simultaneously program the NV memories in multiple finished devices 410. This program information may be of various types, such as but not limited to: 1) a boot loader, 2) software (operating system, application software, or other), 3) a software upgrade, 4) removing user-specific data from devices that have been returned by the user, 5) etc. In some instances, the finished devices 410 may have already been packaged for shipment and/or sale, and the programming can be performed without removing the devices from their packaging. The finished devices 410 may be of various types, such as but not limited to: 1) cell phones, 2) personal data assistants, 3) ultramobile wireless communications devices, 4) laptop or desktop personal computers (PC's), 5) electronic games, 6) other consumer electronic devices, 7) etc.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising
a wireless receiver;
a non-volatile memory;
control logic coupled between the receiver and the non-volatile memory to control writing data into the non-volatile memory;
a wired interface to transfer data into and/or out of the non-volatile memory; and
a first antenna coupled to the wireless receiver to receive a wireless radio frequency signal modulated with data to write into the non-volatile memory, the first antenna having an electrical length of no more than one-half wave length of the received radio frequency wireless signal;
wherein the received wireless signal is to be used to provide operational power to the control logic and to the non-volatile memory during said writing data into the non-volatile memory.

2. The apparatus of claim 1, wherein the first antenna is disposed on a same integrated circuit as the wireless receiver and the wired interface.

3. The apparatus of claim 1, further comprising a substrate, wherein the integrated circuit is attached to the substrate and the first antenna is disposed on the substrate.

4. The apparatus of claim 1, wherein the first antenna is within one wavelength of a second antenna that is transmitting the wireless radio frequency signal.

5. The apparatus of claim 1, further comprising a computer system containing the non-volatile memory, wherein the non-volatile memory is to contain data used by the computer system.

6. The apparatus of claim 1, wherein the received wireless signal has a frequency in the ultra-high frequency (UHF) range.

7. The apparatus of claim 6, wherein the received wireless signal has a frequency of approximately 915 megahertz.

8. A method, comprising:
receiving a wireless signal through a first antenna, the first antenna having an electrical length of no more than one-half wavelength of the wireless signal;
accumulating electrical energy received from the wireless signal through the first antenna;
using at least a portion of the accumulated electrical energy to provide operational power to a non-volatile memory;
decoding data modulated onto the wireless signal; and
writing at least part of the data into the non-volatile memory.

9. The method of claim 8, wherein the wavelength of the wireless signal is between approximately 39 inches and 3.9 inches.

10. The method of claim 8, wherein the wavelength of the wireless signal is approximately 12.9 inches.

11. The method of claim 8, wherein said writing the data comprises writing configuration data for a computer system.

12. An apparatus, comprising:
a computer system to simultaneously program multiple devices by wirelessly transmitting programming data to the multiple devices; and
an antenna coupled to the computer system, the antenna having multiple segments, each segment to be used to communicate programming data to a separate one of the multiple devices, the programming data to be programmed into a non-volatile memory in each of the multiple devices.

13. The apparatus of claim 12, wherein each of the multiple segments are sized for a ultra-high frequency (UHF) band transmission.

14. The apparatus of claim 12, wherein the computer system is further to receive a modulated backscattered signal from each of the multiple devices.

15. A method, comprising:
transmitting, through a multi-segment antenna, a wireless signal modulated to encode data to be programmed into a non-volatile memory in each of multiple devices; and
receiving at least one backscattered signal from each of the multiple devices to acknowledge correct receipt of the data.

16. The method of claim 15, further comprising placing, prior to said transmitting, each one of the multiple devices in a position to shield communications with the associated segment from communications from others of the multiple devices.

17. The method of claim 15, wherein said transmitting comprises transmitting at a frequency of approximately 915 megahertz.

18. The method of claim 15, wherein each segment of the antenna is located within one wavelength of an associated one of the multiple devices

19. An article comprising:
a tangible machine-readable medium encoded with instructions, which when executed by one or more processors result in performing operations comprising:
transmitting, through a multi-segment antenna, a wireless signal modulated to encode data to be programmed into a non-volatile memory in each of multiple devices; and
receiving at least one backscattered signal from each of the multiple devices to acknowledge correct receipt of the data;
wherein each segment of the antenna is located within one wavelength of an associated one of the multiple devices.

20. The medium of claim 19, wherein the operation of transmitting comprises transmitting at a frequency of approximately 915 megahertz.
